(19) United States
(12) Patent Application Publication
(10) Pub. No.: US 2007/0136650 A1
(43) Pub. Date: Jun. 14, 2007

(54) Low power multimedia playing method for portable computer

(75) Inventors: Robert Han Liu, Shenzhen (CN); Han-Che Wang, Shenzhen (CN); Xiao-Guang Li, Shenzhen (CN); Kuan-Hong Hsieh, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,910

(22) Filed: Oct. 27, 2006

(30) Foreign Application Priority Data
Dec. 9, 2005 (CN) 20051012286.5

(51) Int. Cl. G06F 17/00

(52) U.S. Cl. 715/500

(57) ABSTRACT

A computer system capable of playing multimedia files while in a power off mode or power-saving mode is provided. The computer system has a first operating system operated in a high power mode and a second operating system operated in a low power mode. The first operating system has a hard disk storing multimedia files and a central processing unit for running the first operating system. The second operating system has a non-volatile storage unit consuming substantially less power than the hard disk, for storing multimedia files; a multimedia playing unit for playing the multimedia files of the non-volatile storage unit; and a microcontroller having less computing performance than the CPU and consuming substantially less power than the CPU, for running the second operating system when the first operating system is in a power off mode or power-saving mode. A related method for operating the computer system is also provided.

### TECHNICAL FIELD

The present invention relates to computer systems, and particularly to a computer system adapted for low power operation while playing multimedia files and a method of operating the computer system.

### GENERAL BACKGROUND

Personal computers have become indispensable tools for business and personal use. Portable personal computers, generally known as “laptop”, or “notebook” computers have become increasingly popular because their portability allows access to the wide variety of computer applications when traveling, such as on airplanes. However, the usefulness of such portable computers is limited by the power life of batteries powering the computers. Therefore, extending the power life of the batteries becomes a critical problem.

Presently, portable computers carry power-saving functions to solve problems related to inefficient or wasteful power usage. When the computer system remains idle over a certain time period, the computer system power is shut down to conserve power. Generally, the computer system switches to a power-saving mode automatically when idled for a time period preset by the user. When the user wishes to resume a use of the portable computer, the computer system “wakes up”, switching to a normal working mode and supplying power to all components.

However, while in the power-saving mode, the computer is not operable. As a result, the CPU cannot use any audio applications to play music in the power-saving mode. Therefore, if the user wants to play music, the computer system must be in the normal working mode, thus power is supplied to all components. However, while playing music, other functions or devices in the computer system may not be required. Power supplied to corresponding components at this time may be unnecessary.

What is needed, therefore, is a computer system and method adapted for low power consumption while playing music. The system and method is capable of only powering associated components to play music while the other components in the computer system remain in a power off mode or power-saving mode, thus reducing power consumption.

### SUMMARY

A computer system adapted for lower power operation while playing multimedia files is provided. The computer system has a first operating system and a second operating system. The first operating system includes a primary display, a hard disk, and a central processing unit (CPU). The hard disk is for storing data including multimedia files. The CPU is for running the first operating system in a high power mode. The second operating system includes a non-volatile storage unit, a multimedia playing unit, and a microcontroller. The non-volatile storage unit consumes substantially less power than the hard disk and stores multimedia files. The multimedia playing unit is for playing the multimedia files of the non-volatile storage unit. The microcontroller has less computing performance than the CPU and consume substantially less than the CPU. The microcontroller is for running the second operating system when the first operating is in a power off mode or power-saving mode.

A multimedia playing method used in a computer system is also provided. Wherein the computer system has a first operating system and a second operating system, the first operating system operated in a high power mode, and the second operating system operated when the first operating system is in a power off mode or power-saving mode. The method includes the steps of: (a) receiving a play operational input; (b) loading the second operating system in response to the play operational input; and (c) playing multimedia files in the second operating system.

Other advantages and novel features will be drawn from the following detailed description with reference to the attached drawing, in which:

### BRIEF DESCRIPTION OF DRAWINGS

FIG. 1 is a schematic diagram of a hardware infrastructure of a computer system with a first and second operating systems in accordance with a first preferred embodiment of the present invention;

FIG. 2 is a schematic diagram of a hardware infrastructure of a computer system with a first and second operating systems in accordance with an alternative embodiment of the present invention;

FIG. 3 is a flowchart of a first preferred method for playing multimedia files in the second operating system when the first operating system is loaded, by utilizing the computer system of FIG. 1 or FIG. 2; and

FIG. 4 is a flowchart of a second preferred method for playing multimedia files in the second operating system when the first operating system is not loaded, by utilizing the computer system of FIG. 1 or FIG. 2.

### DETAILED DESCRIPTION

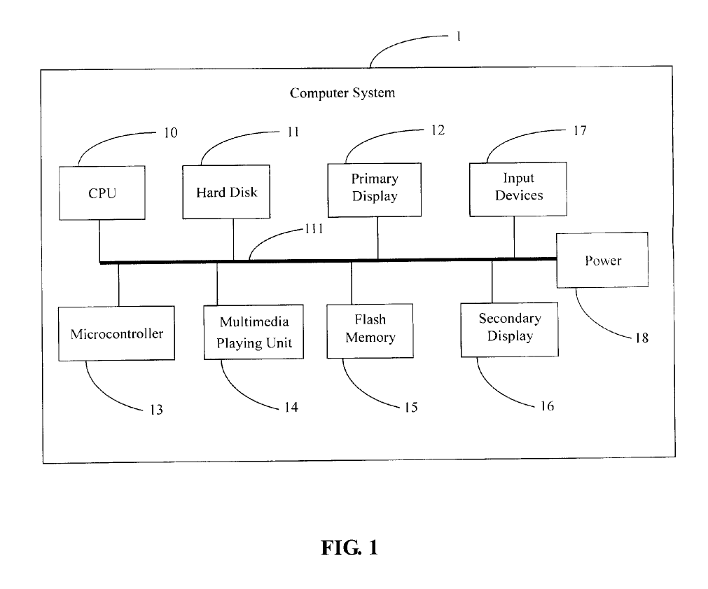

FIG. 1 is a schematic diagram of a hardware infrastructure of a computer system with two operating systems in accordance with a first preferred embodiment of the present invention. The computer system 1 has a first operating system operated in a high power mode and a second operating system operated in a low power mode. The first operating system, e.g., a PC operating system such as any Windows versions developed by Microsoft, is loaded and triggered to operate when the computer system 1 receives a power on operational input from a power on button (not shown). Accordingly, the computer system 1 operates at such, can perform any to all of the computer's full functions such as word processing, email, Internet access, etc, when operating in the first operating system. In other words, the first operating system plays the same role as a conventional computer system.

In comparison to the first operating system, the second operating system has fewer instructions thus, taking up less memory than required by that of the first operating system such as Windows. The second operating system, e.g., an entertainment mini operating system (providing a smaller subset of multimedia functions), is loaded and triggered to operate when the computer system 1 receives a play operational input from a play/pause button. Accordingly, the computer system 1 merely performs a function of playing multimedia when operating with the second operating system. Furthermore, when finishing playing multimedia or receiving a stop operational input from a stop/power button, the computer system 1 switches the second operating system into a power off mode, thus discontinuing power to corresponding hardware managed/operated by the second operating system.

The first operating system operates/manages a central processing unit (CPU) 10, a hard disk 11, and a primary display 12. The CPU 10 is for running the first operating system. The hard disk 11 is for storing data including multimedia files. The primary display 12 is for displaying information when the first operating system is running.

The second operating system operates/manages a microcontroller 13, a multimedia playing unit 14, a non-volatile storage unit 15, and a secondary display 16. The microcontroller 13 has less computing performance than the CPU 10 and consumes substantially less power than the CPU 10. The microcontroller 13 is for running the second operating system in response to the play operational input, that is, the microcontroller 13 is for controlling the multimedia playing unit 14, the non-volatile storage unit 15, and the secondary display 16 to perform corresponding functions, according to the play operational input from the play/pause button.

The non-volatile storage unit 15 is configured for storing multimedia files. The non-volatile storage unit 15 can be a Flash Memory, an Electrically Erasable Programmable Read-Only Memory (EEPROM), or any type of solid-state memory which consumes substantially less power than the hard disk 11. In this exemplary embodiment as shown in FIG. 1, a Flash Memory is adopted for example. The multimedia playing unit 15 is for playing the multimedia files of the non-volatile storage unit 15 (i.e., Flash Memory). The secondary display 16 is for displaying information related to the multimedia files played. In addition, the second display 16 has a smaller size than the primary display 12, thereby consuming substantially less power than the primary display 12.

The computer system 1 further includes a plurality of input devices 17 and a power source 18 (e.g., batteries). The power source 18 is for supplying power to the components of the computer system 1. The input devices 17 are for corresponding multimedia operational inputs such as, multimedia play, next item play, previous item play, stop play, volume adjustment, and so on. Furthermore, the input devices 17 can be in a suitable form, such as mechanical buttons/knobs, touchpad, and so on. In this embodiment, the input devices 17 are in the form of mechanical buttons/knobs. Accordingly, the buttons/knobs include but not limited thereto a play/pause button for playing or pausing multimedia, a stop/power button for stopping play, a skip forward button for playing next item, a skip backward button for playing previous item, and a volume knob for adjusting volume. These input devices 17 can be configured in an appropriate position of the computer system 1 such as, beside the secondary display 16.

Moreover, these components of the computer system 1 are connected to a common data bus 111 (symbolically indicated as a bolded line) such that shown in FIG. 1 for data communication.

Due to the independency of the first and second operating systems, the first operating system can be kept in a power off mode or power-saving mode when the second operating system is running. Therefore, when playing multimedia files (e.g., music), namely receiving the play operational input, the computer system 1 only needs to load the second operating system while has other functions or components not in demand in the power off mode. Furthermore, since the microcontroller 13, non-volatile storage unit 15, and secondary display 16 consume substantially less power than the CPU 10, hard disk 11, and primary display 12 respectively, the computer system 1 is able to reduce power consumption when playing multimedia files, as compared to the conventional computer system that powers the entire computer system to play multimedia files.

In addition, when the computer system 1 receives the play operational input in the event that the first operating system is in a normal working mode, the CPU 10 delays its corresponding executions, that is, the CPU 10 reads the multimedia files from a predetermined position of the hard disk 11 and thereupon stores/copies the multimedia files in the non-volatile storage unit 15 in response to the play operational input. After storing the multimedia files, the CPU 10 resumes its normal processing. Consequently, while in the normal working mode of the first operating system, the computer system 1 can update the multimedia files in the non-volatile storage unit 15 with new multimedia files from the hard disk 11.

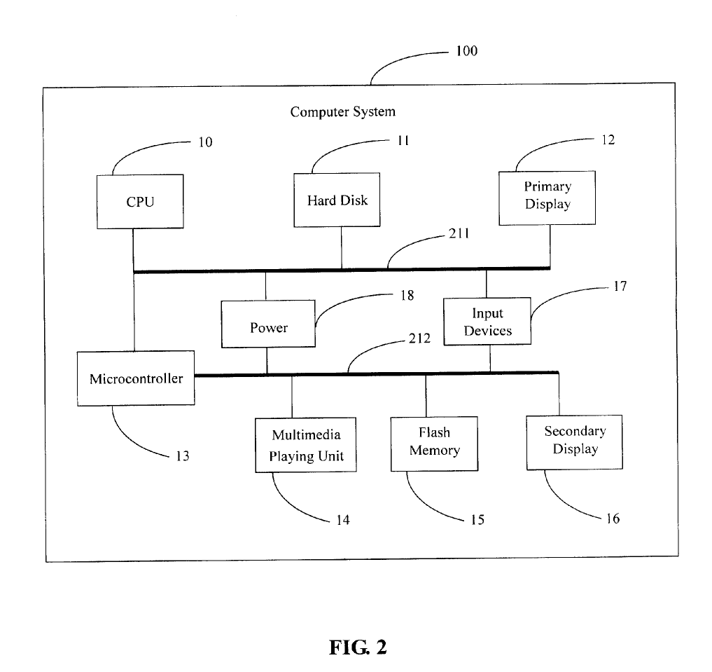

FIG. 2 is a schematic diagram of a hardware infrastructure of a computer system 100 with the first and second operating systems in accordance with an alternative embodiment of the present invention. The computer system 100 of the alternative embodiment has the same components as that of the preferred embodiment, except that the components have two common data buses 211, 212 therebetween such as that shown in FIG. 2. That is, the CPU 10, hard disk 11, primary display 12, microcontroller 13, input devices 17, and power source 18 are connected with a first common data bus 211 (symbolically indicated as a bolded line), while the microcontroller 13, multimedia playing unit 14, non-volatile storage unit 15, secondary display 16, input devices 17, and power source 18 are connected with a second common data bus 212 (symbolically indicated as a bolded line).

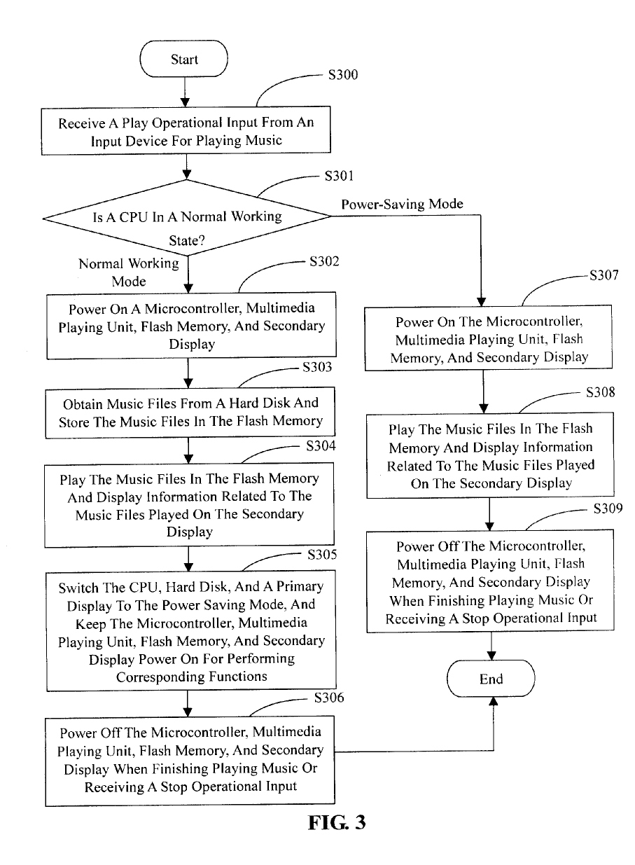

FIG. 3 is a flowchart of a first preferred method for playing multimedia files with the second operating system when the first operating system is loaded, by utilizing the computer system of FIG. 1 or FIG. 2. In step S300, the computer system 1 (or the computer system 100, hereinafter simplified as 100) receives the play operational input from the play/pause button for playing multimedia (e.g., music). In step S301, the computer system 1 (or 100) detects whether the CPU 10 is utilized efficiently, that is, the computer system 1 (or 100) detects a work-rate of the CPU 10 according to a detection application known to persons skilled in the relevant art(s). If the work-rate of the CPU 10 is less than a predetermined value, the procedure goes to step S307 described below.

If the CPU 10 is utilized efficiently, that is, the work-rate of the CPU 10 is equal to or more than the predetermined value, namely where the CPU is in the normal working state, in step S302, the computer system 1 (or 100) has the second operating system loaded, that is, the power source 18 supplies power to the microcontroller 13, multimedia playing unit 14, non-volatile storage unit 15 (e.g., Flash Memory), and secondary display 16.

In step S303, the CPU 10 delays its corresponding executions, that is, the CPU 10 reads the multimedia files (e.g., music files) from the predetermined position of the hard disk 11 and thereupon stores/copies the multimedia files in the non-volatile storage unit 15 in response to the play operational input. After storing the multimedia file, the CPU 10 resumes its normal processing.

In step S304, the second operating system is triggered to operate. That is, the microcontroller 13 controls the multimedia playing unit 14 to play the multimedia files stored in the non-volatile storage unit 15, and displays the information related to the multimedia files currently being played on the secondary display 16. Simultaneously, the computer system 1 (or 100) detects the work-rate of the CPU 10 in real time.

In step S305, the computer system 1 (or 100) switches the first operating system to the power-saving mode if detecting the work-rate of the CPU 10 is less than the predetermined value, that is, the computer system 1 (or 100) switches the CPU 10, hard disk 11, and primary display 12 to the power-saving mode. Due to the independency of the two operating systems, the computer system 1 (or 100) can still have the second operating system operating while switching the first operating system to the power-saving mode, thereby conserving power of the power source 18.

In step 306, the computer system 1 (or 100) switches the second operating system to the power off mode if finishing playing multimedia files or receiving the stop operational input from the stop/power button, and the procedure is finished.

In step S307, namely where the work-rate of the CPU 10 is less than the predetermined value, that is the first operating system is in the power-saving mode, the computer system 1 (or 100) has the second system loaded according to the play operational input, that is, the power source 18 supplies power to the microcontroller 13, multimedia playing unit 14, non-volatile storage unit 15 (e.g., Flash Memory), and the secondary display 16.

In step S308, the second operating system is triggered to operate. That is, the microcontroller 13 controls the multimedia playing unit 14 to play the multimedia files stored in the non-volatile storage unit 15, and displays the information related to the multimedia files currently being played on the secondary display 16.

In step S309, the computer system 1 (or 100) switches the second operating system to the power off mode when finishing playing multimedia files or receiving the stop operational input from the stop/power button, and the procedure is finished.

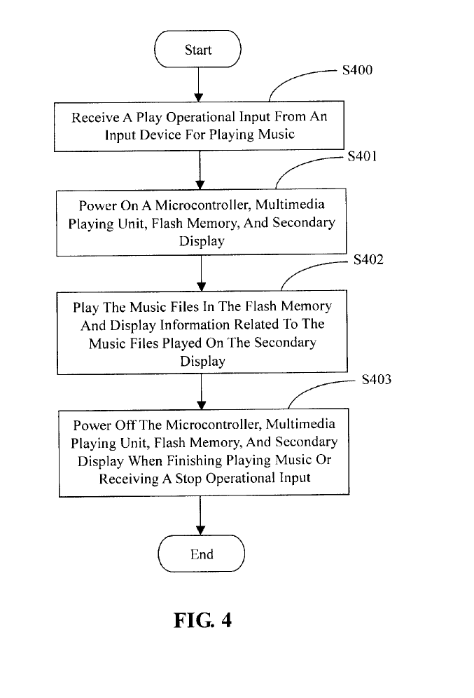

FIG. 4 is a flowchart of a second preferred method for playing multimedia files in the second operating system when the first operating system is not loaded, by utilizing the computer system of FIG. 1 or FIG. 2. In step S400, the computer system 1 (or 100) receives the play operational input from the play/pause button when the first operating system is not loaded.

In step S401, the computer system 1 (or 100) has the second operating system loaded in response to the play operational input, that is, the power source 18 supplies power to the microcontroller 13, multimedia playing unit 14, non-volatile storage unit 15 (e.g., Flash Memory), and the secondary display 16.

In step S402, the second operating system is triggered to operate. That is, the microcontroller 13 controls the multimedia playing unit 14 to play the multimedia files stored in the non-volatile storage unit 15, and displays the information related to the multimedia files currently being played on the secondary display 16.

In step S403, the computer system 1 (or 100) switches the second operating system to the power off mode if finishing playing multimedia files or receiving the stop operational input from the stop/power button, and the procedure is finished.

Therefore, by utilizing the methods of FIG. 3 and FIG. 4, the computer system 1 (or 100) only powers associated components to play multimedia files while the other components in the computer system 1 (or 100) remains in the power off mode or power-saving mode, thus reducing power consumption.

Although the present invention has been specifically described on the basis of a preferred embodiment and preferred method thereof, the invention is not to be construed as being limited thereto. Various changes or modifications may be made to the embodiment and method without departing from the scope and spirit of the invention.

What is claimed is:

1. A computer system comprising:
a first operating system comprising:
a primary display;
a hard disk storing multimedia files; and
a central processing unit (CPU) for running the first operating system; and
a second operating system for playing multimedia files comprising:
a non-volatile storage unit consuming substantially less power than the hard disk, for storing multimedia files;
a multimedia playing unit for playing the multimedia files of the non-volatile storage unit; and
a microcontroller having less computing performance than the CPU and consuming substantially less power than the CPU, for running the second operating system when the first operating system is in a power off mode or power-saving mode.

2. The computer system according to claim 1, wherein the second operating system further comprises a secondary display for displaying information related to the multimedia files being played, wherein the secondary display consumes substantially less power than the primary display.

3. The computer system according to claim 2, further comprising an input device for a play operational input.

4. The computer system according to claim 3, wherein the second operating system is loaded to play the multimedia files in response to the play operational input.

5. The computer system according to claim 4, wherein the first operating system retains in the power off mode or power-saving mode in response to the play operational input.

6. The computer system according to claim 4, wherein the CPU reads the multimedia files from the hard disk and stores the multimedia files read to the non-volatile storage unit, in response to the play operational input in the event that the first operating system is in a normal working mode.

7. The computer system according to claim 4, wherein the second operating system is not loaded if finishing playing the multimedia files.

8. A multimedia playing method used in a computer system, wherein the computer system has a first operating system operated in a high power mode and a second operating system operated in a low power mode, the first operating system having a hard disk storing multimedia files, the second operating system having a non-volatile storage unit storing multimedia files, the multimedia playing method comprising the steps of:
receiving a play operational input;
loading the second operating system in response to the play operational input; and
playing the multimedia files in the second operating system.

9. The method according to claim 8, further comprising the step of: retaining the first operating system in a power off mode or power-saving mode in response to the play operational input.

10. The method according to claim 8, further comprising the step of: reading the multimedia files from the hard disk and storing the multimedia files to the non-volatile storage unit in response to the play operational input in the even that the first operating system is in a normal working mode.

11. The method according to claim 8, further comprising the step of: stopping powering the second operating system if finishing playing the multimedia files.
